(19) United States
(12) Patent Application Publication
(10) Pub. No.: US 2026/0091434 A1
(43) Pub. Date: Apr. 2, 2026

(54) METHOD AND DEVICE FOR SHRINK-FITTING AND REMOVING TOOL SHANKS IN AND FROM THE SLEEVE SECTION OF A TOOL HOLDER IN A MANNER PROTECTED AGAINST OVERHEATING

(71) Applicant: Haimer GmbH, Hollenbach-Igenhausen (DE)

(72) Inventor: Antonin Podhrazky, Jemnice (CZ)

(21) Appl. No.: 19/344,873

(22) Filed: Sep. 30, 2025

(30) Foreign Application Priority Data
Sep. 30, 2024 (DE) 10 2024 128 298.3

(51) Int. Cl. B23B 31/117; H05B 6/10

(52) U.S. Cl. CPC B23B 31/1179; H05B 6/10

(57) ABSTRACT

A method operates a shrink-fitting device having an induction coil for heating the sleeve section of a tool holder while avoiding temperatures that are detrimental to the sleeve section. Provision is made for a plurality of different characteristic variables of the induction process that change during heating, in particular if the sleeve section reaches a critical temperature, to be monitored, and for heating of the sleeve to be ended if at least one of the characteristic variables exceeds a previously defined limit value.

### CROSS-REFERENCE TO RELATED APPLICATION

This application claims the priority, under 35 U.S.C. § 119, of German Patent Application DE 102024128 298.3, filed September 30, 2024; the prior application is herewith incorporated by reference in its entirety.

### FIELD AND BACKGROUND OF THE INVENTION

A method and a device are provided for shrink-fitting and removing tool shanks in and from the sleeve section of a tool holder in a manner protected against overheating

### PRIOR ART

Shrink-fit chucks have been firmly established on the market for many years as tool holders that also meet high machining requirements.

An essential component of any shrink-fit chuck is its sleeve section, which keeps the respective tool shank in a press-fit during operation. This is because the sleeve section has an inside diameter at room temperature that is smaller than the outside diameter of the tool shank to be clamped.

The press-fit is produced during the course of clamping the tool shank. To do this, the sleeve section is inductively heated. As a result, the sleeve section expands to such an extent that its inside diameter is temporarily larger than the outside diameter of the tool shank to be clamped. This tool shank is then inserted into the sleeve section and is held in the press-fit with high force by the sleeve section after they jointly cool down again.

The tool shank is removed from the shrink-fit again in reverse. However, it is necessary to wait for the right time for easy withdrawal of the sleeve section. Specifically, the time at which the sleeve section is already so hot that it has expanded far enough - but not so much heat has yet flowed from the sleeve section into the tool shank that the tool shank also begins to heat up to any significant extent.

A corresponding shrink-fitting device is known from German patent DE 19915412, for example and corresponding to U.S. patent Nos. 6,991,411 and 6,712,367.

There is a certain risk of faults in such a shrink-fitting device, not least during removal from the shrink-fit. Occasionally, operators of the shrink-fitting device may miss the right time to withdraw the tool shank and notice that the tool shank is stuck. In the event of the fault that the sleeve section is not yet hot enough, the operator then continues to heat the sleeve section, which then relatively quickly overheats and suffers damage.

In order to avoid overheating in general, the correct shrinkage parameters have to be set prior to the start of the shrink-fitting process depending on the sleeve section to be heated, these including a limit value for the maximum heating of the shrink-fit chuck or its sleeve section. This is cumbersome and problematic.

For this reason, automatic identification of the shrink-fit chuck and thus also its sleeve section is used in many situations, in order to then automatically set the shrinkage parameters depending on the sleeve section identified.

This works well in practice if the shrink-fit chuck is correspondingly marked, for example by a label or a data chip. However, problems occur if shrink-fit chucks that are not (yet) "chipped" or shrink-fit chucks from suppliers for which no shrink-fit chuck data has yet been stored in the database to which the shrink-fitting apparatus has access are to be shrink-fitted.

In order to also become independent in this respect, measuring the surface temperature of the sleeve section has already been taken into consideration too. However, this does not lead to a satisfactory solution because it is, owing to the skin effect, a highly dynamic heating process - within the scope of which the pure surface temperature can for all intents and purposes already be supercritical long before the decisive temperature is reached deeper in the interior of the sleeve. In addition, such a sensor system would be expensive and complicated.

### SUMMARY OF THE INVENTION

The invention is based on the problem of specifying an operationally reliable method for limiting heating of the sleeve section of a shrink-fit chuck in order to thus be able to prevent overheating of the sleeve section.

### SOLUTION

According to the invention, a novel method for operating a shrink-fitting device having an induction coil is proposed for solving the problem, which heats the sleeve section of a tool holder while avoiding temperatures that are critical for the sleeve section.

With the foregoing and other objects in view there is provided, in accordance with the invention, a method for operating a shrink-fitting device having an induction coil for heating a sleeve section of a tool holder while avoiding temperatures that are detrimental to the sleeve section. The method includes monitoring a plurality of different characteristic variables of an induction process that change during heating, and ending the heating of the sleeve section if at least one of the characteristic variables exceeds a previously defined limit value.

According to the invention, the method is distinguished in that a plurality of characteristic variables of the induction process are monitored - during heating; characteristic variables that change during heating, in particular when the sleeve section approaches a critical value. Heating of the sleeve is ended if at least one of the characteristic variables monitored exceeds a limit value ("switch-off limit value") previously defined for it.

The procedure according to the invention with a plurality of characteristic variables to be used provides a significantly increased guarantee that the sleeve section will not overheat. The various characteristic values can be combined with each other, i.e. in number and type, as desired in order to thus be able to cover all uncertainties.

The invention is based in particular on the finding that the sleeve section, depending on its temperature, in turn influences the behavior of the induction coil so strongly that there are certain electrical characteristic variables of the induction process that, when observed, can be used to identify a characteristic change in the characteristic variable in question, in particular as soon as the sleeve section is about to reach a critical temperature.

It is also possible to make use of the fact that the magnetic behavior, in particular the magnetic permeability of a sleeve section introduced into the induction coil and thus the inductance of the overall system, changes as the temperature of the sleeve section increases. This effect becomes more apparent as the temperature of the sleeve section approaches the Curie point. Nevertheless, the first usable effects can be seen even in the region of the usual switch-off temperatures for shrink-fit chucks in the region of 350°C, in order to thus furthermore define limit values for the characteristic variables.

However, in the temperature range up to 350°C, the dominant factor is the change in the electrical properties of the overall system.

Against this background, it should be noted that, according to the invention, the term "characteristic variable" can include, in particular, both primarily magnetically influenced characteristic variables, such as the inductance of the induction coil, as well as primarily electrically influenced characteristic variables, such as the electrical resistance, current or voltage for example, - and also external factors, such as the heating time, i.e. the duration of the induction process.

Otherwise, a characteristic variable of the induction process may be a characteristic variable to be measured directly, such as the instantaneous active current, the voltage and a heating time for example, or else a characteristic variable that is given by one or more different measured values by calculation.

Owing to the invention, a big step is certainly made towards the goal of being able to safely shrink-fit, and remove from a shrink-fit, such shrink-fit chucks for which no specific characteristic data is available – characteristic data by means of which it is possible to define, even before the start of shrink-fitting or removal from a shrink-fit, how intensively and for how long the sleeve section may be heated by the induction coil.

The characteristic variables used in the context of this invention have the advantage that they are based on effects that occur and can be observed largely or even substantially independently of the size and the exact geometry of the shrink-fit chuck currently being processed with the shrink-fitting apparatus.

In addition, characteristic variables generally exhibit different sensitivities, i.e. characteristic variables react at different speeds in certain temperature ranges for example, so that only a combination of a plurality of characteristic variables can guarantee the above-mentioned safety.

This is a decisive step towards fully autonomous identification of when heating of the sleeve section of a shrink-fit chuck has to be ended.

The combination of the method according to the invention with the problem of initial automatic identification of the shrink-fit chuck, for example by means of an initial electrical test pulse on the shrink-fit chuck which leads either to characteristic feedback such that the shrink-fit chuck in question can be completely identified or at least conclusions can be drawn about its mass and/or geometry and/or dimensions, is particularly expedient. The method according to the invention can be further ensured using such a test pulse.

This approach certainly helps in all cases where a shrink-fit chuck for which no accurate data that can be read by the shrink-fitting device to adjust the shrinkage parameters is available is to be shrink-fitted.

If information about the geometry and dimensions of the shrink-fit chuck in question, for example a length of the shrink-fit chuck, is obtained in this way, i.e. by evaluating the mentioned (initial electrical) test pulse, such as a certain time period until a specified (coil or active) current is reached for example, (or alternatively by explicit prior knowledge), this information can further also be used to possibly define (shrink-fit chuck-)specific switch-off limit values for the monitored characteristic variables - for the respective case or the shrink-fit chuck in question. Where - for example - a first switch-off limit value is defined for a characteristic variable "magnitude of the instantaneous active current" (see below for preferred options) - for an ultra-short shrink-fit chuck, a second, different switch-off limit value for the characteristic variable "magnitude of the instantaneous active current" can be defined - for a long shrink-fit chuck (of identical diameter or similar diameter).

### DESIGN OPTIONS

A preferred electrical characteristic variable to be used is the magnitude of the instantaneous active current. Heating is ended when the instantaneous active current has changed by a certain amount, in particular has fallen, since the start of heating.

The inventor has identified here that the following relationship can be utilized well.

The hotter the sleeve section becomes, the greater the mutual inductance with which it opposes the induction coil used for heating. As a result, the instantaneous active current that is drawn by the induction coil drops. This means that it is possible to conclude that the sleeve section is not yet threatening to reach a critical temperature, provided that the instantaneous active current has not yet fallen by a certain amount.

Another or additional option is to use the instantaneous change in the active current as a characteristic. Heating can be ended, for example, when the active current no longer changes by a certain minimum amount – or specifically when the active current changes again (by a certain (minimum) amount).

The inventor has identified here that although the instantaneous active current initially continues to decrease as the temperature increases, the speed at which the active current decreases noticeably decreases when the sleeve section is about to reach its critical temperature.

Yet another or additional option is to use the second derivative of the instantaneous active current with respect to time as a characteristic. The second derivative of the instantaneous active current with respect to time approaches zero if the sleeve section is about to reach its critical temperature.

Yet another or additional option is to use the heating time (from the start of heating) as a characteristic variable. The corresponding limit value thus defines a maximum heating time (after which the heating process is ended or heating is switched off).

Furthermore, the instantaneous inductance of the overall system containing the induction coil and the shrink-fit chuck can also be used as the characteristic variable, for example such that it is determined by test signals during ongoing heating - and these values are controlled with respect to limit values.

Furthermore, energy from a current that has flowed since the start of heating, in particular the coil current, and/or the integral of the active current that has flowed since the start with respect to time can also be used as a characteristic, in particular even when the approximate size of the shrink-fit chuck had initially been determined by an electrical pulse and therefore information about the total electrical active energy that can be approximately applied is available before the sleeve section reaches its critical temperature.

In particular, it has proven to be advantageous to predict the profile of the characteristic variables using mathematical methods, e.g. using a Kalman filter.

Other features which are considered as characteristic for the invention are set forth in the appended claims.

Although the invention is illustrated and described herein as embodied in a method and a device for shrink-fitting and removing tool shanks in and from the sleeve section of a tool holder in a manner protected against overheating, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a mid-longitudinal sectional view of an induction coil unit according to one embodiment of the invention;

FIG. 2 is a circuit diagram of a circuit for feeding an induction coil that can be used for implementing the invention; and

FIG. 3 is a graph showing a selection of characteristic variables that can be used according to the invention.

### DETAILED DESCRIPTION OF THE INVENTION

Ideally, the method according to the invention is prepared by a learning process not illustrated in the figures here. For this purpose, shrink-fit chucks with sleeve sections of different sizes and thicknesses are used.

It is usually expedient to first apply a test pulse, which is generated by briefly energizing the induction coil, to the sleeve section of each of these shrink-fit chucks. Depending on its size and thickness, the sleeve section opposes the test pulse with a greater or lesser mutual inductance. From this, a fairly reliable conclusion can be drawn as to the dimensions of the sleeve section and its expected behavior during inductive heating.

This allows a plausibility check on the instantaneous values that the characteristic variables of the induction coil used for assessing the switch-off time currently exhibit and therefore facilitates the safe switch-off according to the invention.

In many cases, it is particularly expedient to design the method according to the invention in a self-learning manner. For this purpose, it is advisable to measure, store and – with respect to the shrink-fitting process – evaluate the characteristic values of the induction coil used for subsequently assessing when switch-off has to be performed for each shrinking-fitting process on an existing shrink-fitting device.

This works particularly well with a fully manually operated shrink-fitting device since operating actions by the operator can be recorded or feedback from the operator about the shrink-fitting process can be determined/recorded or checked here.

This feedback can be used to draw conclusions about the quality of the shrink-fitting process – and thus shrinkage parameters and switch-off criteria can also be optimized, preferably using artificial intelligence.

Here, for example, shrink-fitting is performed such that the device operator manually pushes the tool shank in the direction of the tool chuck of the sleeve section and then activates the induction coil using the other hand. This action comes to an end as soon as the sleeve section has expanded far enough and therefore the tool shank slides into the tool chuck of the sleeve section – after which the device operator deactivates the induction coil. Removal from a shrink-fit again is performed analogously. The device operator pulls the tool to be removed from the shrink-fit again using one hand, activates the induction coil with the other hand and stops the process as soon as the tool shank can be withdrawn from the sleeve section.

If a large number of characteristic curves have been recorded in this way for the characteristic variables of the induction coil used for assessing the switch-off time, it is possible to very finely determine or verify the changes typically exhibited by the characteristic curves of the characteristic variables in question close to the switch-off time or when it is reached.

Further optimization options can be realized by the shrink-fitting device measuring temperature profiles by means of a suitable sensor system when shrink-fitting shrink-fit chucks – and using these real temperature profiles to optimize parameter sets. This can be done in particular and preferably by artificial intelligence once again.

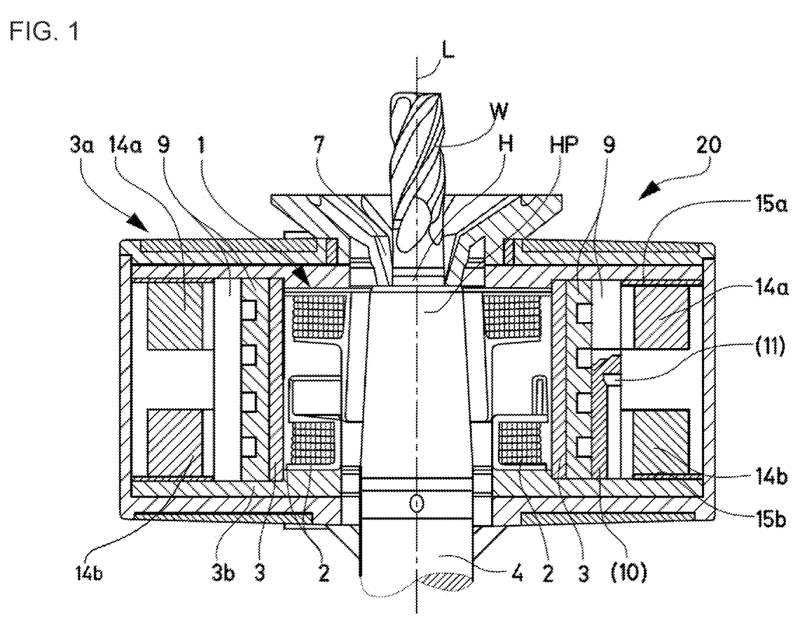

Referring now to the figures of the drawings in detail and first, particularly to FIG. 1 thereof, there is shown a basic structure of an induction coil unit, which will also be referred to as a shrink-fitting apparatus due to its intended function here.

As illustrated in FIG. 1, the shrink-fitting apparatus provides an induction coil 1 with individual turns 2, in the center of which a tool holder 4 is inserted in order to shrink-fit or remove the holding shaft H of a tool W, such as here a milling cutter for example, into or from the sleeve section HP.

The operating principle on which the shrink-fitting and removal is based is described in more detail in non-prosecuted German patent application DE 19915412 A1. The content thereof is hereby incorporated into the subject matter of this application.

On its outer circumference, the induction coil 1 is provided with a first sheath 3 composed of electrically non-conductive and magnetically permeable material. Typically, the first sheath 3 consists of either a ferrite or a metal powder or metal sintered material, the individual particles of which are isolated from one another in electrically insulated fashion and which are thereby, on the whole, substantially magnetically permeable and electrically non-conductive.

The first sheath 3 is also configured such that it is predominantly self-enclosed in the circumferential direction, that is to say largely covers the peripheral surface of the induction coil 1, such that, in theory, there are also no remaining "magnetic gaps" whatsoever, aside from irrelevant local apertures, such as individual and/or small local bores or the like.

As furthermore also shown in FIG. 1, in the shrink-fitting apparatus 20, the shielding made of magnetically permeable and electrically non-conductive material does not end with the first sheath 3. Instead, a magnetic cover 3a, 3b made of the material adjoins at least one, better still both end faces of the first sheath 3, and is generally in contact with the first sheath 3. On the end face of the induction coil 1 remote from the tool holder 4, the magnetic cover 3a is preferably designed as a completely or preferably partially replaceable pole shoe, i.e. as a ring-shaped structure having a central opening, which forms a passage 7 for the tool W to be clamped in or released.

On the end face of the induction coil 1 facing the tool holder 4, the magnetic cover 3b is preferably configured as an inherently planar annular disc, which ideally fully engages over the windings of the induction coil 1 and has a central passage for the sleeve section HP.

In order to even further improve the shielding, as also shown in FIG. 1, the induction coil 1 and its first sheath 3, on the outer circumference thereof, are surrounded by a second sheath 9 – specifically such that the first sheath 3 and the second sheath 9 touch one another, ideally over the majority of or the entirety of their mutually facing peripheral surfaces.

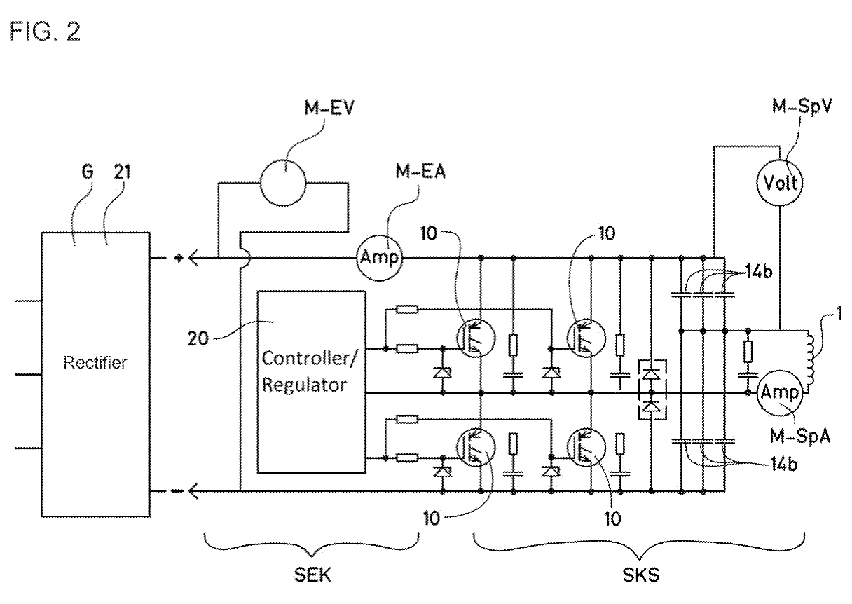

FIG. 2 shows the associated circuit. It has a resonant circuit SKS (cf. FIG. 2).

In the resonant circuit SKS, the majority of the required energy oscillates periodically back and forth (at high frequency) between the induction coil 1 used for heating the sleeve section and a capacitor unit 14a, 14b. This means that, in each period or periodically, only the energy extracted from the resonant circuit SKS through its heating power and its other power losses needs to be fed back. The previous very high losses are thus no longer incurred.

The power electronics supplying power to the induction coil 1, as shown in FIG. 2, are supplied on the input side with the generally available mains current NST, which, in Europe (three-phase current, 3f), is 400 V/50 Hz (corresponding values in other countries). The current taken from the grid, as illustrated in FIG. 2, is converted, by a rectifier G 21, into direct current, which in turn is smoothed by the one or more smoothing capacitors (not shown).

As furthermore also illustrated in FIG. 2, this direct current is supplied to the actual resonant circuit SKS.

The backbone of the resonant circuit SKS is formed by the power semiconductor components 10, the resonant circuit capacitors 14b and the induction coil 1, which serves for shrink-fitting and removal from a shrink-fit.

The resonant circuit SKS is controlled or regulated by control electronics SEK, which are supplied with direct current from the rectifier G.

The power semiconductor components 10 are preferably implemented by insulated-gate bipolar transistors, IGBT for short.

The control electronics SEK switch the power semiconductor components 10 at a frequency that specifies the operating frequency that sets in at the resonant circuit SKS.

It is important that the resonant circuit SKS never operates exactly in resonance. This would result here in the rapid destruction of the power semiconductor components 10 as a result of the voltage peaks. Instead, the control electronics SEK are designed such that they operate the power electronics or their resonant circuit SKS in a pre-definable working range, which is only close to the resonance or natural frequency of the system.

Preferably, the resonant circuit is controlled or regulated (by way of the controller 20) such that 0.9 ≤ cos p ≤ 0.99. Values in the range 0.95 ≤ cos p ≤ 0.98 are particularly expedient. This again leads to voltage peaks being avoided, and therefore provides further support for miniaturization.

In order to operate the shrink-fitting device 1 with a certain degree of operational safety – in a manner as automated as possible – the shrink-fitting apparatus is equipped with an automatic heating controller/regulator that enables automated shrink-fitting operation. This heating controller/regulator is implemented by a corresponding controller or regulator 20 in the shrink-fitting apparatus, which is based – fundamentally – on an analysis of – measured – coil current M-SpA, coil voltage M-SpV and/or input current M-EA and/or input voltage M-EV or their temporal profiles.

In order to measure coil current (M-SpA), coil voltage (M-SpV) and input current (M-EA) and input voltage (M-EV), the circuit, as also shown in FIG. 2, accordingly makes provision for current/voltage measuring implements M-SpA (coil current), M-SpV (coil voltage) or M-EA (input current) or M-EV (input voltage), which are installed accordingly in the circuit at correspondingly shown positions.

According to the invention, the following procedure is followed.

Before the start of heating of the sleeve section introduced into the induction coil, the geometry or the outside diameter of the sleeve section introduced into the induction coil is preferably first determined - in an automated manner.

For this purpose, a test pulse of the induction coil, which is generated by briefly energizing the induction coil, is first applied to the sleeve section. Depending on its size and thickness, the sleeve section opposes the test pulse with a greater or lesser mutual inductance. This method for generating a "fingerprint" of a sleeve section is known per se.

This "fingerprint" is evaluated and compared with the respective mutual inductance which is stored in the database as a kind of "fingerprint" for other sleeve sections. In many cases, it is thus possible to identify the type of shrink-fit chuck, so that the appropriate parameter set – with shrinkage parameters to be used, including the associated overheating protection logic system (i.e. which characteristic values with which limit values) – can then be a priori selected and preset.

The procedure according to the invention, which is to be explained in more detail once again, then serves only to provide additional assurance that the maximum permissible heating of the sleeve section is not exceeded. An extremely high level of assurance is provided in this case because stored information defined for specific shrink-fit chucks, for example how large the drop in the instantaneous active current may be, the maximum amount of heating energy that may be supplied overall etc. (characteristic values and their limit values), can be used.

If no suitable parameter set can be found, the invention can nevertheless be used to perform shrink-fitting without having to do without extensive protection against overheating of the sleeve section.

The "response" or the fingerprint of the sleeve section of the chuck to be shrink-fitted is then preferably evaluated at least to the effect that a conclusion is drawn therefrom about the size/mass and/or geometry and/or shape of the as such unknown sleeve section – and in this way a parameter set is "estimated".

A particularly preferred embodiment of the shrink-fitting device according to the invention is then equipped such that it then defines the maximum heating energy that can presumably be supplied to the sleeve section before it overheats, and that the maximum amount by which the instantaneous active current in a sleeve section, as presumably found in the shrink-fitting device, may have fallen is established before there is a threat of the sleeve section overheating.

The heating process for the sleeve section then starts. The instantaneous active current is measured and adjusted. The heating process is ended or prevented from continuing further if the instantaneous active current has fallen to the extent that is stored for the case that a sleeve section comparable to the fingerprint is just about to overheat. If the integral of the instantaneous active current with respect to time earlier becomes so large that it can be assumed that a sleeve section with the fingerprint taken at the outset starts to overheat because the maximum permissible heating energy has already been supplied, the heating process is then also ended or prevented from continuing further - regardless of the fact that the instantaneous active current has not yet fallen to the extent that should actually be the case if the presumed sleeve section is about to overheat.

If the procedure is to be performed even more safely, then at least one further characteristic variable of the induction process will be used and taken into account in addition to the two characteristic variables already taken into account in any case, so that the heating process is ended as soon as only one of these three or more characteristic variables has reached a value from which it can be inferred that the sleeve section is just about to overheat.

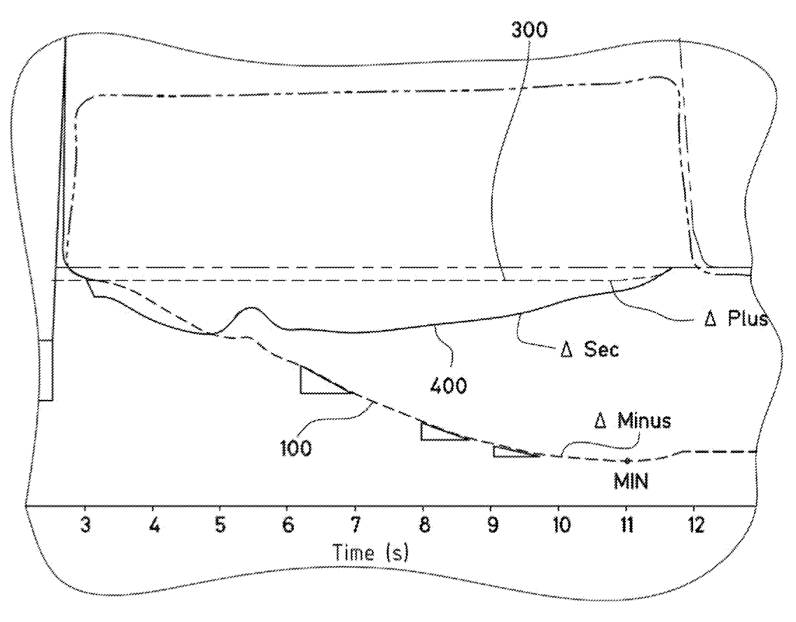

Reference may be made to FIG. 3 for further illustration of this approach.

Curve 100 represents the instantaneous value for the active current, plotted over time. It is easy to see that the active current currently flowing decreases significantly with time, i.e. with increasing heating of the sleeve section. This behavior is exhibited by all sleeve sections, no matter if small or large; only the magnitude values are different.

Thus, the amount by which the instantaneous active current has decreased can be used as a characteristic variable to trigger switch-off. This can be done at least when the fingerprint of the sleeve section to be shrink-fitted determined on the basis of the input can be plausibly deduced from its geometry.

The first derivative of curve 100 with respect to time is illustrated by the slope triangles on the curve 100 (cf. FIG. 1, three slope triangles shown). It is a measure of the fact that the decrease in the instantaneous active current flattens or completely ceases, as is the case just before a sleeve section starts to overheat. This flattening as such is also exhibited by all sleeve sections since the tendency of the tangents to zero is easy to detect. In general, it is particularly preferable to use the tangents here. This is because the flattening can always be observed regardless of the mass or the geometry of the current sleeve section. This therefore involves a characteristic value that can be reliably used even if the test pulse described at the outset cannot generate a reasonably assignable fingerprint of the sleeve section to be shrink-fitted, so that an estimate of the extent to which the magnitude of the instantaneous active current may drop in the specific case is difficult.

Curve 300 only evaluates the increase in the active current. It is a statement of when the active current rises again, this indicating the proximity to the critical temperature or the situation of the critical temperature being exceeded. This, too, is a reliable characteristic variable that can be used to determine whether a sleeve section, regardless of its size or nature, is just about to overheat. This is because, when this is the case, curve 300 tends towards zero.

Curve 400 was calculated from curve 100 - using a Kalman filter - and represents the second derivative of curve 100. It is a statement of how quickly the steepness of curve 100 decreases. Kalman filters as such are well known. However, the use of a Kalman filter in this context is novel.

The Kalman filter is used to estimate system variables that are not directly measurable, while the measurement errors are optimally reduced. For dynamic variables, a mathematical model can be added to the filter as a secondary condition in order to take into account dynamic relationships between system variables.

This can also be used to very reliably prevent the sleeve section from overheating. The fingerprint, obtained according to the method described at the outset, of the unknown sleeve section can be used to draw conclusions about the general nature of the sleeve and the extent to which, therefore, the instantaneous active current will drop when the sleeve is just about to overheat, so that this criterion can be used as obscured.

For safety, however, care is also taken to ensure that the situation of the curve of the instantaneous active current becoming severely flattened is identified in good time, even if the absolute value of the instantaneous active current has not fallen to such an extent that would have actually been expected in accordance with the fingerprint of the sleeve section.

The integral of the instantaneous active current with respect to time can then also be used as additional assurance. This also results in a switch-off if the other two criteria should fail because currently neither the absolute drop in the actual active current nor the theoretically supplied heating energy is such that an overheating would actually be expected.

1. A method for operating a shrink-fitting device having an induction coil for heating a sleeve section of a tool holder while avoiding temperatures that are detrimental to the sleeve section, which comprises the steps of:
monitoring a plurality of different characteristic variables of an induction process that change during heating; and
ending the heating of the sleeve section if at least one of the characteristic variables exceeds a previously defined limit value.

2. The method according to claim 1, wherein one of the characteristic variables is an active current and the heating is ended if an instantaneous active current has fallen by a certain amount since a start of the heating.

3. The method according to according to claim 1, wherein one of the characteristic variables is an instantaneous change in an active current and the heating is ended if the active current no longer changes by a certain minimum amount.

4. The method according to claim 1, wherein one of the characteristic variables is an instantaneous rate of change in an active current and the heating is ended if the active current does not change at a certain minimum rate.

5. The method according to claim 1, wherein one of the characteristic variables is energy from a current that has flowed since a start of the heating, and/or an integral of an instantaneous active current that has flowed since the start of the heating with respect to time.

6. The method according to claim 1, wherein one of the characteristic variables is a heating time since a start of the heating.

7. The method according to claim 1, wherein an instantaneous inductance of an overall system containing the induction coil and the shrink-fit chuck is used as one of the characteristic variables.

8. The method according to claim 1, wherein one of the characteristic variables is an instantaneous phase angle between an instantaneous active current and a voltage driving it.

9. The method according to claim 1, wherein one of the characteristic variables is an instantaneous inductance of the induction coil.

10. The method according to claim 1, wherein a measurement signal supplied by at least one electrical characteristic variable passes through a digital smoothing filter before it is evaluated.

11. The method according to claim 1, which further comprises determining an identity of the shrink-fit chuck or at least characteristics of the sleeve section or its mass/thickness and/or size and/or geometry is/are in advance by means of a test pulse.

12. The method according to claim 1, wherein parameter sets are optimized on a basis of real data from shrink-fitting processes.

13. The method according to claim 1, wherein one of the characteristic variables is a critical temperature of the sleeve section.

14. The method according to claim 5, wherein the energy from the current that has flowed since the start of the heating is a coil current.

15. The method according to claim 1, wherein an instantaneous inductance of an overall system containing the induction coil and the shrink-fit chuck is used as one of the characteristic variables such that the one characteristic variable is determined by test signals during ongoing heating and is controlled with respect to a limit value.

16. The method according to claim 10, wherein the digital smoothing filter is a Kalman filter.

17. The method according to claim 12, wherein the real data from the shrink-fitting processes includes temperature curves and/or feedback from users and/or user behavior derived using artificial intelligence.

18. A shrink-fitting device, comprising:
an induction coil;
at least one current and/or voltage detector either in an intermediate circuit of a frequency converter serving to supply electrical energy to a coil circuit and/or in said coil circuit;
a comparator comparing at least two characteristic variables of an induction process with limit values specified for them and, if a limit value is exceeded for at least one characteristic variable, heating of the induction coil stops or further heating of the induction coil is stopped; and
the shrink-fitting device configured for carrying out the method according to claim 1.
